(19) United States
(12) Patent Application Publication
(10) Pub. No.: US 2026/0252821 A1
(43) Pub. Date: Aug. 27, 2026

(54) System and Method for Validating and Transforming Machine-Readable Cybersecurity Data into Natural Language for Language Model Integration

(71) Applicant: Oliver Szimmetat, Redmon, WA (US)

(72) Inventor: Oliver Szimmetat, Redmon, WA (US)

(21) Appl. No.: 19/059,358

(22) Filed: Feb. 21, 2025

(51) Int. Cl. G06F 40/58; G06F 16/34; G06F 40/103; G06F 40/166

(52) U.S. Cl. CPC G06F 40/58; G06F 16/345; G06F 40/103; G06F 40/166

(57) ABSTRACT

A system and method for validating and transforming machine-readable cybersecurity information into natural language for enhanced processing by language models are disclosed. The system performs schema mapping to convert element or tag names into readable text, eliminates unnecessary elements, and replaces acronyms with meaningful descriptions in one or more languages. It maps locale-specific formats to standardized formats (e.g., UTC) and converts numerical values into standardized text representations (e.g., severity levels). The system generates language blocks to provide context, describing elements, attributes, and parent-child relationships, and structures data into coherent sentences based on target language syntax. A validation process identifies missing definitions, unmapped values, unexpected relationships, and data inconsistencies. Once validated, the data is transformed into natural language and uploaded to a language model for ingestion or retraining, enhancing the model's ability to interpret, analyze, and respond to cybersecurity threats effectively.

### FIELD OF THE INVENTION

The present invention relates to cybersecurity and artificial intelligence, specifically to a system and method for transforming machine-readable cybersecurity information into natural language representations. More particularly, the invention provides a framework for validating, structuring, and optimizing cybersecurity data for enhanced usability in language models, improving interpretability and response accuracy for security analysts and automated systems.

### BACKGROUND

As cybersecurity threats continue to evolve in complexity and scale, organizations increasingly rely on automated threat intelligence feeds and machine-readable data formats such as Structured Threat Information Expression (STIX), Trusted Automated eXchange of Indicator Information (TAXII), and internal machine-readable data sources that are used to get more information about the architecture/security posture of a system, including software bill of materials (SBOM), or OSCAL, and other structured cybersecurity frameworks. These formats are designed to facilitate rapid machine-to-machine communication, enabling real-time threat detection, sharing, and analysis. However, while highly efficient for automated processing, such structured data presents significant challenges when interfaced with systems that rely on natural language understanding, particularly large language models (LLMs) and AI-driven cybersecurity tools.

Language models have become essential components in modern cybersecurity workflows, supporting tasks such as automated threat analysis, incident response, vulnerability assessment, and the generation of cybersecurity reports. These models excel at processing and generating insights from unstructured, human-readable text. However, their effectiveness diminishes when tasked with interpreting rigid, structured data formats. The lack of natural language context and semantic richness in machine-readable data limits the models'ability to derive meaningful insights, often resulting in incomplete or inaccurate threat assessments.

Conventional approaches to bridging this gap involve static rule-based transformation techniques or simplistic parsing methods. These approaches frequently suffer from critical shortcomings, including the loss of important contextual details, semantic inaccuracies, and an inability to adapt to new or evolving threat intelligence formats. This not only reduces the accuracy of threat analysis but also increases the cognitive load on cybersecurity analysts who must manually interpret and verify the transformed data. Therefore, there is a pressing need for an advanced method and system capable of both validating machine-readable cybersecurity data for accuracy and completeness and transforming it into coherent, contextually enriched natural language. Such a solution would ensure that the integrity of the original data is preserved while enhancing its interpretability for language models and human analysts alike. This capability would significantly improve the efficiency of cybersecurity operations, enabling faster, more accurate responses to emerging threats.

The present invention addresses these challenges by introducing a comprehensive framework that integrates robust data validation protocols with advanced natural language transformation techniques. By bridging the gap between structured machine-readable cybersecurity data and natural language processing systems, this invention enhances the ability of AI models to generate actionable insights, ultimately strengthening cybersecurity defenses and response strategies.

### BRIEF SUMMARY

In an aspect, the present invention provides a system and method for validating and transforming machine-readable cybersecurity information into natural language for enhanced processing by language models. The system includes a processor, and a memory coupled to the processor, the memory storing instructions that, when executed by the processor, cause the system to perform schema mapping to map element or tag names from the machine-readable cybersecurity information to more readable strings in one or more target languages. The system is further configured to eliminate unnecessary elements and attributes from the machine-readable cybersecurity information to optimize data clarity. The system is further configured to replace acronyms and abbreviations with meaningful text in one or more target languages. The system is further configured to map locale-specific formats to a standardized format, including but not limited to UTC date and time formats. The system is further configured to map numerical values to meaningful, standardized text representations, wherein predefined mappings are applied (e.g., severity level “0” is mapped to “Critical”). The system is further configured to generate language blocks that provide additional context, wherein the language blocks describe the meaning of elements, attributes, and parent-child relationships, and structure the information into coherent sentences based on language-specific syntax rules. The system is further configured to validate the transformed data by identifying missing descriptions, unmapped numerical values, unexpected parent-child relationships, and source text in unexpected languages. The system is further configured to transform the validated machine-readable cybersecurity information into natural language in one or more target languages. The system is further configured to upload the transformed natural language data to a target language model for ingestion or retraining.

In an embodiment of the present invention, the schema mapping includes mapping multiple machine-readable data formats, including STIX, TAXII, and JSON, to corresponding natural language descriptors.

In a further embodiment of the present invention, the elimination of unnecessary elements and attributes is based on predefined rules or dynamic relevance scoring to reduce data redundancy.

In a further embodiment of the present invention, the replacement of acronyms and abbreviations includes referencing an external or internal dictionary containing mappings for cybersecurity-specific terminology in multiple languages.

In a further embodiment of the present invention, mapping locale-specific formats includes converting date, time, currency, and measurement units to a standardized format recognized by the target language model.

In a further embodiment of the present invention, mapping numerical values to text includes using a customizable mapping table that allows administrators to define specific numerical-to-text relationships for different cybersecurity metrics.

In a further embodiment of the present invention, the language blocks are generated using predefined sentence templates that are dynamically adjusted based on the syntactic and grammatical rules of the target language.

In a further embodiment of the present invention, the validation process provides real-time alerts for missing data, undefined acronyms, unexpected data types, and invalid parent-child relationships, enabling corrective actions before final transformation. This also enables an assessment of the input dataset's quality and the overall reliability of the data source.

In a further embodiment of the present invention, the transformation process can be configured to generate both technical summaries and human-readable reports tailored for different audiences, including cybersecurity analysts and executive stakeholders. It can also identify the most effective method for distributing information based on its type (e.g., threat intelligence vs. recommendations or best practices). For example, the system may automatically send a Slack message to the relevant audience or generate a Jira ticket to initiate a workflow for further investigation.

In a further embodiment of the present invention, the uploading process includes secure data transfer protocols and application programming interfaces (APIs) for seamless integration with different types of language models.

In another aspect, the present invention provides a method for validating and transforming machine-readable cybersecurity information into natural language for enhanced processing by language models. The method comprising the steps of performing schema mapping to map element or tag names from the machine-readable cybersecurity information to more readable strings in one or more target languages. The method further comprising the steps of eliminating unnecessary elements and attributes from the machine-readable cybersecurity information to improve data clarity. The method further comprising the steps of replacing acronyms and abbreviations with meaningful text in one or more target languages. The method further comprising the steps of mapping locale-specific formats to standardized formats, including UTC date formats. The method further comprising the steps of mapping numerical values to meaningful, standardized text representations. The method further comprising the steps of providing language blocks to add context by describing the meaning of elements, attributes, and parent-child relationships, and structuring them into coherent sentences according to target language rules. The method further comprising the steps of validating the transformed data to detect missing descriptions, unmapped values, unexpected relationships, and inconsistent source languages. The method further comprising the steps of transforming the validated machine-readable cybersecurity information into natural language in one or more target languages. The method further comprising the steps of uploading the transformed data to a target language model for ingestion or retraining.

The disclosed system and method offer several advantages by bridging the gap between machine-readable cybersecurity data and natural language processing for language models. It enhances the interpretability of complex cybersecurity information by transforming rigid, structured data formats into coherent, context-rich natural language, enabling more accurate threat analysis and incident response. The system ensures data integrity through robust validation processes that identify missing definitions, unexpected values, and inconsistencies, reducing the risk of misinterpretation. By standardizing numerical values, locale-specific formats, and replacing acronyms with meaningful descriptions, it improves data clarity across multiple languages and regions. The use of dynamic language blocks and sentence templates allows for adaptable, multi-language support, making the transformed data accessible to both technical and non-technical audiences. Additionally, seamless integration with language models for ingestion or retraining optimizes AI-driven cybersecurity operations, enhancing threat detection, automated reporting, and decision-making processes in real time.

### BRIEF DESCRIPTION OF THE ACCOMPANYING DRAWINGS

The novel features which are believed to be characteristic of the present invention, as to its structure, organization, use, and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a schematic representation showcasing a system environment within which different embodiments of the present invention can be implemented and operationalized.

FIG. 2 is a block diagram that illustrates an exemplary process flow for validating and transforming machine-readable cybersecurity information into natural language for enhanced processing by language models, in accordance with an embodiment of the present invention.

FIG. 3 is a block diagram that illustrates essential steps of a method for validating and transforming machine-readable cybersecurity information into natural language for enhanced processing by language models, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an”, and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the Figures may be exaggerated, relative to other elements, to improve the understanding of the present invention. There may be additional components described in the foregoing application that are not depicted on one of the described drawings. In the event such a component is described, but not depicted in a drawing, the absence of such a drawing should not be considered as an omission of such design from the specification.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. Unless stated otherwise, terms such as “first” and “second” are used to arbitrarily distinguish between the elements. Thus, these terms are not necessarily intended to indicate temporal or other prioritization of such elements. While various exemplary embodiments of the disclosed invention have been described below it should be understood that they have been presented for purposes of example only, not limitations. It is not exhaustive and does not limit the invention to the precise form disclosed. Modifications and variations are possible considering the above teachings or may be acquired from practicing of the invention, without departing from the breadth or scope.

The present invention provides a comprehensive system and method for validating and transforming machine-readable cybersecurity information. The cybersecurity information refers to any data that pertains to the security posture, vulnerabilities, threats, risks, and protective measures associated with digital systems, networks, and environments. This information is crucial for identifying, analyzing, mitigating, and responding to cybersecurity incidents. Cybersecurity information includes standard threat intelligence data, which consists of indicators of compromise (IOCs), attack patterns, malware signatures, adversary tactics, techniques, and procedures (TTPs), as well as reports on vulnerabilities and exploits. Additionally, cybersecurity information is not limited to traditional threat intelligence but also encompasses machine-generated and machine-readable files that describe the current state, configuration, and security landscape of an IT system or network. Examples of such data include AWS Config files, which provide details about cloud resource configurations; OSCAL (Open Security Controls Assessment Language) documentation, which standardizes security control assessments and compliance reporting; and SBOMs (Software Bill of Materials), which catalog software components to help detect vulnerabilities and manage dependencies. These machine-readable formats enable automated security assessments, real-time monitoring, and compliance verification, making them essential for modern cybersecurity operations. By structuring and processing cybersecurity information effectively, organizations can enhance threat detection, streamline compliance workflows, and improve overall security resilience.

The present invention provides a comprehensive system and method for validating and transforming machine-readable cybersecurity information into natural language, specifically designed to enhance processing and analysis by language models. In today's cybersecurity landscape, organizations rely heavily on structured data formats like STIX, TAXII, and JSON for automated threat intelligence sharing. While these formats are efficient for machine-to-machine communication, they pose significant challenges for natural language processing (NLP) systems, including large language models (LLMs), which excel in handling unstructured, human-readable text. Traditional data transformation methods often fail to preserve the semantic integrity of the data, leading to inaccurate interpretations, loss of critical context, and ineffective threat mitigation. To address this problem, the present invention introduces a multi-step framework that begins with schema mapping, where machine-readable elements or tags are mapped to more readable, human-friendly strings in one or more target languages. The system then eliminates unnecessary elements and attributes to streamline the data, followed by the replacement of acronyms and abbreviations with their full, meaningful descriptions to improve clarity. It further enhances data consistency by mapping locale-specific formats, such as dates, times, and measurement units, to standardized formats like UTC, and converting numerical values into standardized text representations (e.g., mapping severity level “0” to “Critical”), making the data more interpretable for language models. A key feature of the invention is the generation of language blocks, which provide additional context by describing the meaning of individual data elements, attributes, and the relationships between parent and child data structures. These language blocks use dynamic sentence templates tailored to the syntax of the target language, ensuring that the transformed data is not only accurate but also grammatically coherent. Before final transformation, the system performs a thorough validation process to identify missing definitions, unmapped numerical values, unexpected parent-child relationships, and language inconsistencies. This validation ensures data integrity and prevents the loss of critical information during transformation. Once validated, the system transforms the machine-readable data into natural language, producing output that is both technically accurate and easy to understand. Finally, the transformed data is uploaded to a target language model for ingestion or retraining, enabling the language model to generate more precise and contextually rich insights when processing cybersecurity-related queries. By bridging the gap between structured cybersecurity data and NLP systems, this invention significantly improves the efficiency of threat detection, incident response, and cybersecurity reporting, making complex threat intelligence accessible to both AI systems and human analysts.

The present invention will now be described with reference to the accompanying drawings which should be regarded as merely illustrative without restricting the scope and ambit of the present invention.

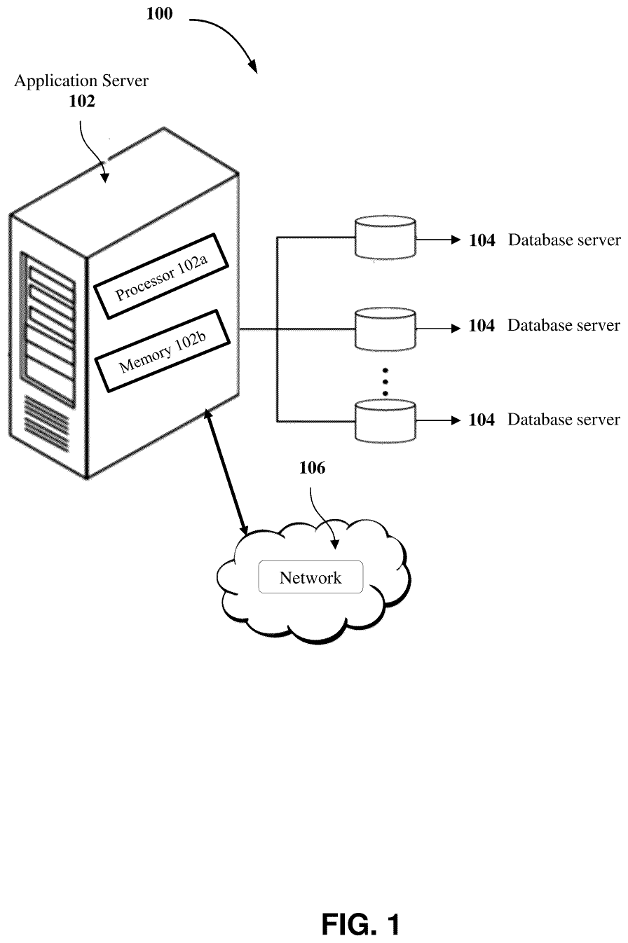

FIG. 1 is a schematic representation showcasing a system environment 100 within which different embodiments of the present invention can be implemented and operationalized. The system environment 100 includes an application server 102 including one or more components or elements such as processor 102a and a memory 102b. The system environment further includes a database server 104. Furthermore, the application server 102, the database server 104, and other system devices may be configured to communicate with each other via a communication network 106.

The application server 102 is an essential component of the system architecture, designed to manage, execute, and deliver application-specific functionalities to end users and connected devices. The application server 102 acts as a middleware platform that bridges the gap between user interfaces (e.g., mobile or web applications) and backend resources, such as databases, computational services, and external APIs. The application server 102 is a software or hardware framework that provides an environment for running applications, executing business logic, and facilitating communication between users and backend systems. Examples of application servers 102 include Apache Tomcat, JBoss, Microsoft IIS, and AWS Lambda for serverless applications. These servers can host a variety of services, such as e-commerce platforms, financial systems, and content management systems. The system for validating and transforming machine-readable cybersecurity information into natural language is powered by the application server 102 designed to execute the core functionalities of the disclosed method. This application server 102 is a critical component that facilitates data processing, transformation, validation, and integration with language models. The application server 102 is configured with key hardware and software elements, including a processor and memory, which work in tandem to ensure efficient execution of the system's operations.

The processor 102a is the computational engine of the application server 102, responsible for executing instructions, performing calculations, and managing data flow throughout the system. In the context of the disclosed invention, the processor 102a is configured to perform several operations such as:
Schema Mapping: The processor 102a runs algorithms to map machine-readable elements, such as tags or data fields from cybersecurity formats (e.g., STIX, TAXII), to human-readable strings in one or more target languages. This requires real-time computation to handle large datasets and complex data structures efficiently.
Data Elimination and Transformation: The processor 102a executes logic to eliminate unnecessary elements and attributes, optimizing data for clarity and relevance. It also processes replacement functions for acronyms and abbreviations, converting them into full, meaningful text.
Locale and Numerical Mapping: The processor 102a handles the conversion of locale-specific formats (e.g., date and time) into standardized formats (like UTC) and maps numerical values to standardized text (e.g., mapping severity scores to descriptive labels such as “Critical” or “Low”).
Natural Language Generation: Using language models and predefined sentence templates, the processor 102a assembles coherent, contextually rich natural language outputs from structured data inputs, adjusting for syntax variations across different target languages.
Validation Logic: The processor 102a performs data validation by running checks for missing elements, unexpected values, undefined parent-child relationships, and inconsistencies in data formatting or language.

The processor 102a may be a multi-core unit or part of a distributed architecture to support high-speed, parallel processing, especially for large-scale cybersecurity datasets.

The memory 102b in the application server 102 includes both volatile memory (such as RAM) and non-volatile memory (such as SSDs or hard drives), providing temporary and persistent storage for data and instructions. The memory 102b plays a crucial role in supporting the system's real-time processing requirements. The temporary data storage (RAM) stores active data during processing tasks, such as raw machine-readable cybersecurity files, intermediate transformation outputs, schema mappings, and validation logs. This enables quick access for the processor during real-time operations like data parsing, validation, and transformation. The persistent storage i.e., non-volatile memory stores critical system resources, such as:
Mapping Databases: Persistent dictionaries for schema mappings, acronym expansions, locale settings, and numerical-to-text conversion rules.
Language Templates: Sentence structures and syntax rules for multiple languages, used in generating natural language outputs.
Validation Rules: Repositories of validation criteria, including expected data types, parent-child relationships, and known abbreviations.
Audit Logs and Process History: Records of past data transformations, validation errors, and system performance metrics for compliance and monitoring purposes.

Additionally, memory supports caching mechanisms to optimize performance, especially when dealing with frequently accessed mappings or recurring data validation tasks.

The application server 102 may be configured with both software modules and APIs to manage seamless integration with external systems, such as language models and cybersecurity data sources. Key configurations include:
Input/Output Interfaces: The server 102 can receive machine-readable files in various formats (e.g., XML, JSON) and output transformed natural language files compatible with language models.
Secure Upload Module: A secure communication protocol is integrated to upload the validated and transformed natural language files to target language models for ingestion or retraining.
Real-Time Monitoring: The server 102 is equipped with monitoring tools to track data flow, processing status, and validation outcomes, providing real-time feedback and alerts in case of errors.

Furthermore, given the volume and complexity of cybersecurity data, the application server 102 may be designed for scalability. It can operate in a cloud-based environment or an on-premise infrastructure depending on organizational needs. It supports load balancing and parallel processing to handle large datasets efficiently, ensuring minimal latency during data validation and transformation processes.

The database server 104 is a computing environment that provides database services to other programs or devices, often functioning within a client-server architecture. The database server 104 is a specialized component responsible for storing, organizing, managing, and retrieving data essential for the system's operations. It serves as a central repository where all critical information is securely maintained. Examples of database servers 104 include MySQL, PostgreSQL, MongoDB, and Oracle Database. These servers use structured query languages (SQL) or NoSQL-based architectures to handle vast amounts of data with high efficiency and security.

In an embodiment, the database server 104 plays a critical role in managing, storing, and retrieving the structured and unstructured data required for validating and transforming machine-readable cybersecurity information into natural language. The database server 104 stores key datasets such as schema mapping definitions, acronym and abbreviation dictionaries, locale-specific format configurations, numerical-to-text conversion tables, language templates for natural language generation, and validation rules. It also maintains audit logs and historical records of data transformations, validation errors, and system activities, which are essential for compliance, system monitoring, and performance optimization. This structured repository enables the application server to quickly access and update the necessary data during real-time processing tasks, ensuring efficient and accurate data transformation.

The communication network 106 serves as the backbone for data exchange between the application server 102 and the database server 104. This network 106 can be configured as a secure local area network (LAN), wide area network (WAN), or a cloud-based infrastructure, depending on deployment requirements. It supports encrypted data transmission to safeguard sensitive cybersecurity information during transit, employing protocols such as HTTPS, TLS, or VPNs to ensure secure communication channels. The network 106 facilitates seamless, low-latency interactions, allowing the application server to retrieve and update mapping schemas, validation rules, and language templates in real-time as it processes incoming cybersecurity data. Additionally, the network 106 enables the secure transfer of the final transformed natural language files to target language models for ingestion or retraining, ensuring the integrity and confidentiality of the data throughout the process. Together, the database server 104 and communication network 102 create a robust infrastructure that supports the system's high-performance requirements for cybersecurity data processing and transformation.

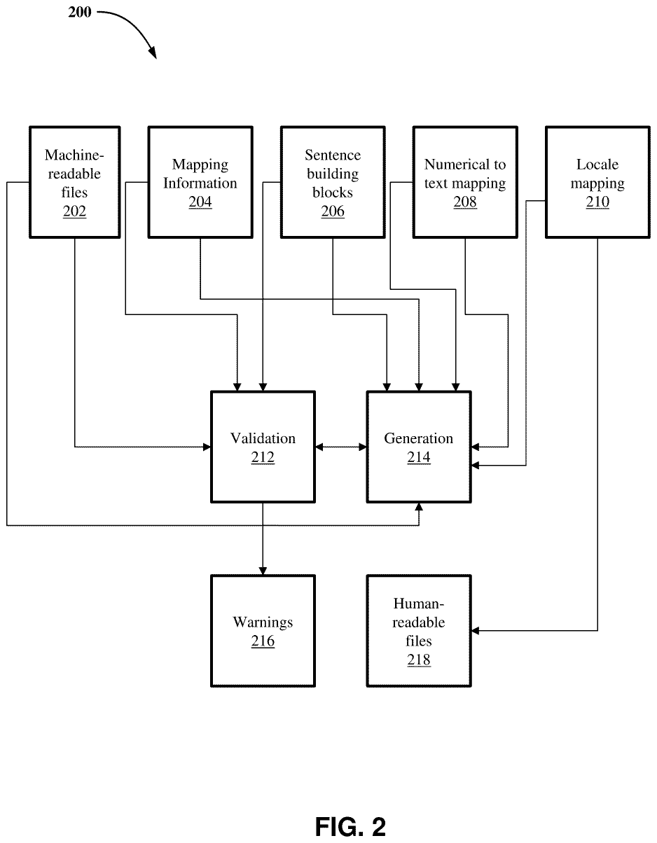

FIG. 2 is a block diagram that illustrates an exemplary process flow for validating and transforming machine-readable cybersecurity information into natural language for enhanced processing by language models, in accordance with an embodiment of the present invention. The disclosed invention features a comprehensive system architecture 200 designed to validate and transform machine-readable cybersecurity information into natural language, facilitating seamless processing by language models. The process begins with the machine-readable files block 202, which receives structured cybersecurity data from formats such as STIX, TAXII, or JSON. This raw data lacks the semantic clarity required for natural language processing, necessitating transformation through various interconnected system components. The mapping information block 204 plays a pivotal role by providing schema mappings that convert technical data elements, such as tags and attributes, into more human-readable descriptors. For example, a tag like <threat_level>could be mapped to “Threat Severity Level.” This mapped information is communicated to both the validation block 212 and the generation block 214. The validation block 212 ensures that all required mappings are present and correct, while the generation block 214 uses these mappings to construct natural language outputs.

The sentence building block 206 introduces linguistic structure, transforming discrete data points into coherent sentences. For instance, cybersecurity data containing an IP address and a corresponding threat score might be structured as: “The IP address 192.168.1.1 has been identified with a critical threat score.” This block 206 also sends information to both the validation and generation blocks 212 and 214 to ensure sentence construction aligns with predefined linguistic rules. The numerical-to-text mapping block 208 standardizes numerical data by converting it into descriptive text. For example, a numerical severity score of “0” might be mapped to “Critical,” enhancing interpretability. Like the other mapping components, it communicates with both the validation and generation blocks 212 and 214 to ensure data consistency and correct transformation. The locale mapping block 210 handles localization tasks, such as converting date and time formats to UTC or adjusting currency symbols and measurement units based on the target language or region. This block 210 communicates directly with the generation block 214 to support accurate localization and also interfaces with the human-readable files block 218 to ensure the final output aligns with regional preferences. The validation block 212 serves as the system's quality control checkpoint. It cross-references data from the mapping information, sentence building, and numerical-to-text mapping blocks to identify inconsistencies, missing mappings, or unexpected data relationships. For example, if an expected parent-child data relationship is missing or an undefined acronym appears, the validation block 212 flags these issues. When such anomalies are detected, it communicates directly with the warnings block 216 to generate alerts, allowing users to address potential data quality issues before final transformation. The generation block 214 synthesizes all validated data, mappings, and linguistic structures to produce coherent, natural language outputs. This block works closely with the validation block 212 in a two-way communication loop, enabling real-time feedback and adjustments during the transformation process. Finally, the system outputs the transformed data to the human-readable files block 218, generating reports or data files in natural language, suitable for cybersecurity analysts or integration into language models. This output is enriched with contextual details from the locale mapping block, ensuring cultural and linguistic appropriateness. Thus, this architecture ensures that complex machine-readable cybersecurity data is not only accurately validated and transformed but also contextually enriched, making it highly interpretable for both AI models and human users. The interconnected communication pathways between the blocks enable dynamic validation, real-time error detection, and robust natural language generation, addressing the core challenge of converting rigid, structured data into meaningful, actionable insights.

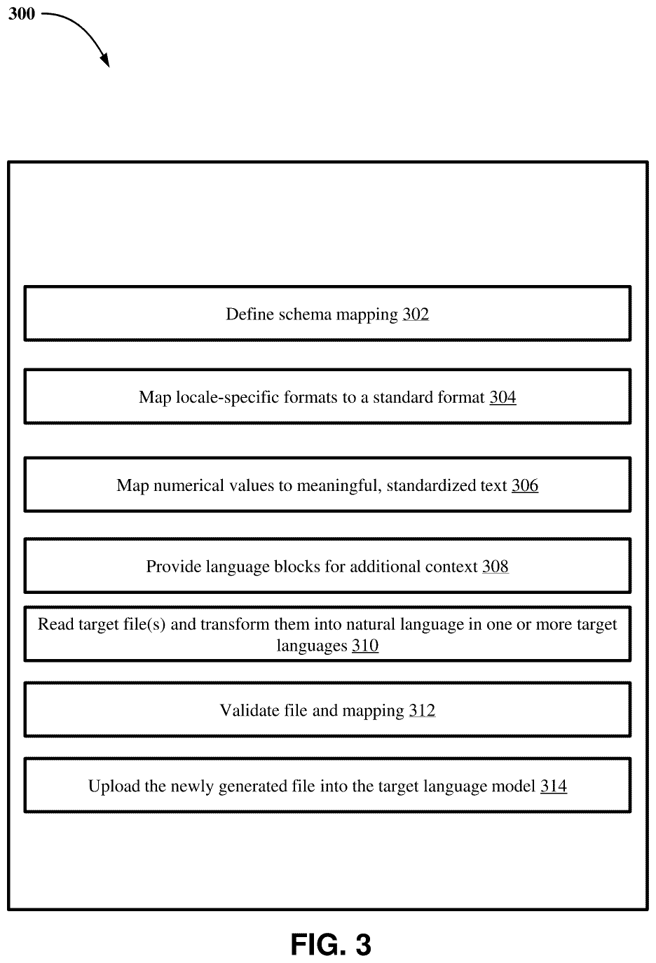

FIG. 3 is a block diagram that illustrates essential steps of a method 300 for validating and transforming the machine-readable cybersecurity information into natural language for enhanced processing by the language models, in accordance with an embodiment of the present invention. At step 302, the method includes schema mapping. Schema mapping is the foundational step where machine-readable data elements, such as tags, attributes, and fields, are mapped to more human-readable descriptions. This process involves creating a mapping framework that links technical data structures (e.g., <threat_level>, <src_ip>) to meaningful text representations like “Threat Severity Level” or “Source IP Address.” The mapping may also account for language-specific nuances when supporting multiple languages. For example, the field <alert_code>in a cybersecurity file could be mapped to “Security Alert Code” in English, “Codigo de Alerta de Seguridad” in Spanish, and so on. This ensures that the data becomes more accessible and contextually relevant during the transformation process.

At step 304, the method includes map locale-specific formats to a standard format. Cybersecurity data often includes locale-specific information, such as date and time formats, currency symbols, measurement units, or language-specific characters. This step standardizes such data to ensure consistency across different regions and systems. For example, dates may appear as “MM/DD/YYYY” in the U.S. but as “DD/MM/YYYY” in Europe. This method converts all date formats to a universal standard like UTC (Coordinated Universal Time) to eliminate ambiguities. Similarly, time zones, currency notations, or metric conversions (e.g., Fahrenheit to Celsius) are normalized to maintain data integrity, making it easier for language models to process information uniformly.

At step 306, the method includes mapping numerical values to meaningful, standardized text. In cybersecurity data, numerical values often represent specific metrics, such as severity levels, risk scores, or confidence ratings. Raw numbers can be ambiguous without context, so this step converts numerical data into descriptive text for better clarity. For example: a severity score of “0” might be mapped to “Critical,” a risk score of “5” could be converted to “High Risk,” and a confidence level of “80%” could be described as “Very Likely.” This mapping ensures that numerical values are presented in a way that is both understandable to human readers and easily interpretable by language models, improving the accuracy of automated threat analysis and reporting.

At step 308, the method includes providing the language blocks for additional context. Language blocks are contextual templates or structures that help convert data elements into complete, coherent sentences. These blocks define how data should be organized linguistically, considering syntax, grammar, and semantic relationships. They describe the meaning of individual elements, the significance of parent-child data relationships, and how these should be presented in natural language. For instance, a machine-readable file containing: <src_ip>192.168.1.1</src_ip>and <threat_level>0</threat_level>could be transformed using a language block into: “The source IP address 192.168.1.1 has been identified with a critical threat level.” The sentence structure might vary based on the target language, ensuring proper localization and natural flow in translations.

At step 310, the method includes reading the target file(s) and transform them into natural language in one or more target languages. In this step, the system reads the input files containing machine-readable cybersecurity information. Using the schema mappings, locale conversions, numerical-to-text mappings, and language blocks defined earlier, the system transforms the structured data into natural language. The transformation process is flexible enough to support multiple target languages, adjusting sentence structures and contextual elements as needed. For example, while English might follow a subject-verb-object sentence order, other languages like Japanese or German may require different arrangements. The output is coherent, grammatically correct, and contextually accurate, making the data more usable for both human analysts and AI systems.

At step 310, the method includes validating file and mapping. Validation is an essential step that ensures the accuracy and completeness of the transformed data. The system checks for: (1) missing definitions, for example, elements or attributes without corresponding schema mappings, (2) unknown abbreviations, such as acronyms that haven't been expanded or defined, (3) unexpected values, such as data type mismatches, such as a string where a number is expected, (4) incorrect parent-child relationships, such as structural inconsistencies in the data hierarchy, and language inconsistencies, such as text appearing in an unexpected source language. If validation issues are detected, the system generates warnings, alerting users to potential errors before the data is finalized. This step prevents data loss, misinterpretation, and inaccuracies in cybersecurity reports or language model outputs.

At step 312, the method includes uploading the newly generated file into the target language model. After successful validation and transformation, the final natural language file is uploaded to a target language model for ingestion or retraining. This process typically involves secure data transfer protocols to ensure data integrity and confidentiality, especially when dealing with sensitive cybersecurity information. The transformed data enhances the language model's ability to process cybersecurity-related content, improving its performance in threat detection, incident analysis, and automated reporting tasks. The integration can be achieved via APIs, batch uploads, or real-time data streams, depending on system configurations and requirements.

The disclosed system and method for validating and transforming machine-readable cybersecurity information into natural language have wide-ranging applications across cybersecurity operations, artificial intelligence, and data analytics. One of the primary applications is in automated threat intelligence processing, where structured data from formats like STIX and TAXII can be seamlessly converted into human-readable reports, enabling faster and more accurate decision-making for security analysts. Additionally, the system can be integrated with language models for cybersecurity automation, enhancing the models' ability to interpret, analyze, and respond to cybersecurity incidents without relying on rigid, structured data inputs. This improves tasks such as automated incident response, vulnerability assessment, and security report generation. Furthermore, the system is highly valuable in regulatory compliance and auditing, where complex security logs and threat data need to be presented in clear, standardized formats for legal and compliance teams. It also supports multi-language cybersecurity reporting, making it adaptable for global organizations that require threat intelligence in different languages.

The advantages of this invention are multifaceted. First, it significantly improves data interpretability by transforming complex, machine-readable cybersecurity data into coherent, context-rich natural language, which enhances the efficiency and accuracy of both human and AI-driven analysis. The system's robust validation mechanisms ensure data integrity by detecting errors such as missing mappings, undefined abbreviations, or inconsistent parent-child relationships, reducing the risk of misinterpretation and information loss. Its ability to standardize locale-specific formats and map numerical values to meaningful text ensures that data is not only accurate but also contextually relevant across different regions and languages. Moreover, the system is highly scalable and can handle large volumes of cybersecurity data in real-time, making it suitable for both small security teams and large-scale enterprise environments. The integration with language models for continuous learning and retraining further enhances the models'capabilities, leading to more effective automated threat detection and response. Ultimately, the invention bridges a critical gap between structured cybersecurity data and natural language processing, enabling faster, more informed, and globally accessible cybersecurity operations.

The present invention integrates tangible hardware components, including servers, processors, memory, (FIG. 1), to achieve a unified system for validating and transforming machine-readable cybersecurity information into natural language have wide-ranging applications across cybersecurity operations, artificial intelligence, and data analytics. These physical components work in tandem to perform specific, concrete functions. The server 102, comprising processors and memory, form the backbone of the system by performing computationally intensive tasks. Thus, the disclosed invention should not be considered abstract or non-patentable because it embodies specific, concrete technological processes and implements practical applications that solve real-world cybersecurity challenges. While the invention involves data transformation and processing, it goes far beyond mere data manipulation or theoretical concepts. The system introduces a specific, structured architecture comprising functional blocks, such as the machine-readable files block, mapping information block, sentence building block, numerical-to-text mapping block, locale mapping block, validation block, generation block, warnings block, and human-readable files block. These components interact through well-defined communication pathways, performing tangible data validation, transformation, and integration with language models. This concrete system architecture and the technical operations it performs clearly demonstrate that the invention is rooted in practical applications rather than abstract ideas. Moreover, the invention provides a technological solution to a technological problem. The problem addressed is the inability of language models to effectively process machine-readable cybersecurity data, which lacks natural language context. The solution is not a generic computer implementation but rather a detailed method involving schema mapping, locale-specific data standardization, numerical-to-text conversion, and context-aware language generation. Each step in this process is meticulously defined and contributes to the overall functionality of the system. For example, the validation mechanism is not just a theoretical check but an active, dynamic process that detects missing mappings, unexpected data relationships, and anomalies, ensuring the integrity and reliability of the transformed data. This adds a layer of technical improvement to existing cybersecurity data processing methods, making the system more efficient and accurate. Additionally, the invention demonstrates specific improvements in computer functionality, particularly in the fields of natural language processing and cybersecurity automation. The ability to transform rigid, structured data formats like STIX and TAXII into coherent, human-readable language enhances the performance of AI models, enabling them to generate more accurate, contextually relevant insights. This is a significant advancement over traditional data parsing methods, which often result in loss of critical information and reduced data interpretability. The invention's capacity to process multi-language data, handle real-time validations, and support continuous learning models further illustrates its technical depth and practical utility, characteristics that distinguish it from abstract ideas. The system also involves features, such as the integration of schema mapping with dynamic language blocks, real-time validation protocols, and the bidirectional communication between validation and generation blocks. These elements are not standard practices in cybersecurity data processing or NLP systems and require inventive concepts to implement effectively. Furthermore, the invention results in tangible outputs, validated, natural language files that are directly usable by language models and human analysts, providing measurable improvements in cybersecurity threat detection, reporting, and compliance management.

The foregoing descriptions of specific embodiments of the present technology have been presented for purposes of illustration and description. They are not intended to be exhaustive or to limit the present technology to the precise forms disclosed, and obviously many modifications and variations are possible considering the above teaching. The embodiments were chosen and described to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology. While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A system for validating and transforming machine-readable cybersecurity information into natural language for enhanced processing by language models, the system comprising:
a processor;
a memory coupled to the processor, the memory storing instructions that, when executed by the processor, cause the system to:
perform schema mapping to map element or tag names from the machine-readable cybersecurity information to more readable strings in one or more target languages;
eliminate unnecessary elements and attributes from the machine-readable cybersecurity information to optimize data clarity;
replace acronyms and abbreviations with meaningful text in one or more target languages;
map locale-specific formats to a standardized format, including but not limited to UTC date and time formats;
map numerical values to meaningful, standardized text representations, wherein predefined mappings are applied;
generate language blocks that provide additional context, wherein the language blocks describe the meaning of elements, attributes, and parent-child relationships, and structure the information into coherent sentences based on language-specific syntax rules;
validate the transformed data by identifying missing descriptions, unmapped numerical values, unexpected parent-child relationships, and source text in unexpected languages;
transform the validated machine-readable cybersecurity information into natural language in one or more target languages; and
upload the transformed natural language data to a target language model for ingestion or retraining.

2. The system of claim 1, wherein the schema mapping includes mapping multiple machine-readable data formats, including STIX, TAXII, and JSON, to corresponding natural language descriptors.

3. The system of claim 1, wherein the elimination of unnecessary elements and attributes is based on predefined rules or dynamic relevance scoring to reduce data redundancy.

4. The system of claim 1, wherein the replacement of acronyms and abbreviations includes referencing an external or internal dictionary containing mappings for cybersecurity-specific terminology in multiple languages.

5. The system of claim 1, wherein mapping locale-specific formats includes converting date, time, currency, and measurement units to a standardized format recognized by the target language model.

6. The system of claim 1, wherein mapping numerical values to text includes using a customizable mapping table that allows administrators to define specific numerical-to-text relationships for different cybersecurity metrics.

7. The system of claim 1, wherein the language blocks are generated using predefined sentence templates that are dynamically adjusted based on the syntactic and grammatical rules of the target language.

8. The system of claim 1, wherein the validation process provides real-time alerts for missing data, undefined acronyms, unexpected data types, and invalid parent-child relationships, enabling corrective actions before final transformation.

9. The system of claim 1, wherein the transformation process can be configured to generate both technical summaries and human-readable reports tailored for different audiences, including cybersecurity analysts and executive stakeholders.

10. The system of claim 1, wherein the uploading process includes secure data transfer protocols and application programming interfaces (APIs) for seamless integration with different types of language models.

11. A method for validating and transforming machine-readable cybersecurity information into natural language for enhanced processing by language models, the method comprising the steps of:
performing schema mapping to map element or tag names from the machine-readable cybersecurity information to more readable strings in one or more target languages;
eliminating unnecessary elements and attributes from the machine-readable cybersecurity information to improve data clarity;
replacing acronyms and abbreviations with meaningful text in one or more target languages;
mapping locale-specific formats to standardized formats, including UTC date formats;
mapping numerical values to meaningful, standardized text representations;
providing language blocks to add context by describing the meaning of elements, attributes, and parent-child relationships, and structuring them into coherent sentences according to target language rules;
validating the transformed data to detect missing descriptions, unmapped values, unexpected relationships, and inconsistent source languages;
transforming the validated machine-readable cybersecurity information into natural language in one or more target languages; and
uploading the transformed data to a target language model for ingestion or retraining.
